(19) United States
(12) Patent Application Publication
(10) Pub. No.: US 2008/0144654 A1
(43) Pub. Date: Jun. 19, 2008

(54) SYMBOLIC REPRESENTATION OF PROTOCOL-SPECIFIC INFORMATION

(76) Inventors: Leo Frishberg, Portland, OR (US); Eric Gould Bear, Austin, TX (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(21) Appl. No.: 11/612,639

(22) Filed: Dec. 19, 2006

(51) Int. Cl. H04J 3/16

(52) U.S. Cl. 370/466

(57) ABSTRACT

A method of displaying data includes receiving data, extracting protocol-specific information from the data, converting the protocol-specific information into a symbolic representation, and presenting the symbolic representation.

In addition, a test and measurement instrument for displaying data includes an acquisition system configured to receive an input signal, a processor coupled to the acquisition system and configured to generate a symbolic representation of protocol-specific information within the input signal, and a user interface configured to present the symbolic representation.

### BACKGROUND

Analyzing and debugging systems using communications among their components has become increasingly difficult. Rising complexity, increasing performance, and variety of protocols within a circuit present difficult obstacles for validation engineers attempting to identify and track errors.

A protocol analyzer is an instrument that is designed to display, validate, and measure communications. Such communications may include data in a variety of protocols. The protocol analyzer typically presents packets and transactions for analysis by a user. The packets and transactions are typically represented in a “box car” format by displaying boxes with a text label for a field of a packet and a text message corresponding to the data within the field. A color may be used to distinguish fields from one another.

Unfortunately, data from differing protocols are displayed in the same “box car” format. Thus, without a detailed inspection of a field of the data, the user cannot determine a difference between the protocols or between packets within a protocol. In addition, the box car diagrams for different protocols may be displayed in separate screens, making it difficult to correlate events among the protocols.

In addition, packets are commonly displayed with earlier fields on the left and later fields on the right. Subsequent packets are displayed below older packets. Although a packet may have a field indicating a time, there is no visual indicator of the time relationship of the packets. In particular, there is no visual indicator of a time relationship between packets from different channels or communications links. Thus, it is difficult for a user to correlate the occurrence of packets over time. Although a user may reorder the packets to view packets associated with a particular transaction, there is no visual indication of the time relationship of that transaction with other packets or transactions.

Furthermore, a user may zoom in or out on the display of the packets. However, since the information contained within the fields of the packets are represented by text, as a user zooms out, the text eventually becomes unintelligible. Thus, it is difficult for a user to both view a large number of packets and still be able to determine the information contained within the packet.

Users are typically most interested in errors. A different color may indicate that a field, packet or other structure may include an error. However, since color has been used extensively, to identify different fields, a different color for an error does not draw the user's attention to it in a sea of other colors. In addition, users are able to arbitrarily assign colors. As a result, the use of color to indicate an error is reduced further.

Accordingly, a need remains for an improved display of protocol-specific information.

### SUMMARY

An embodiment of the invention includes a method of displaying data including receiving data, extracting protocol-specific information from the data, converting the protocol-specific information into a symbolic representation, and presenting the symbolic representation.

Another embodiment of the invention includes a test and measurement instrument for displaying data including an acquisition system configured to receive an input signal, a processor coupled to the acquisition system and configured to generate a symbolic representation of protocol-specific information within the input signal, and a user interface configured to present the symbolic representation.

### BRIEF DESCRIPTION OF THE DRAWINGS

FIG. 1 is a block diagram of a test and measurement instrument providing a symbolic display of data according to an embodiment of the invention.

FIG. 2 is an example of a symbol grammar for a symbolic representation according to an embodiment of the invention.

FIG. 3 is an example of adornment of symbols of FIG. 2.

FIG. 4 is an example of a symbolic display of various states of a split-pair transaction using the symbol grammar of FIG. 2.

FIG. 5 is a flowchart illustrating a method of displaying a symbolic representation of data according to an embodiment of the invention.

FIG. 6 is a flowchart illustrating a method of displaying a symbolic representation of data according to another embodiment of the invention.

FIG. 7 is a flowchart illustrating a method of displaying a symbolic representation of data according to another embodiment of the invention.

FIG. 8 is a flowchart illustrating a method of displaying a symbolic representation of data according to another embodiment of the invention.

FIG. 9 is an example of semantic zooms of a symbolic representation according to an embodiment of the invention.

FIGS. 10 and 11 are an illustration of a passage of time and a formation of transactions in a symbolic display according to an embodiment of the invention.

FIG. 12 is an example of a legend for a symbolic representation according to an embodiment of the invention.

FIG. 13 is a flowchart illustrating a method of displaying a symbolic representation of data according to another embodiment of the invention.

FIG. 14 is an example of a display of protocol-specific information at multiple levels of abstraction.

### DETAILED DESCRIPTION

Embodiments described herein use a symbolic representation of protocol-specific data.

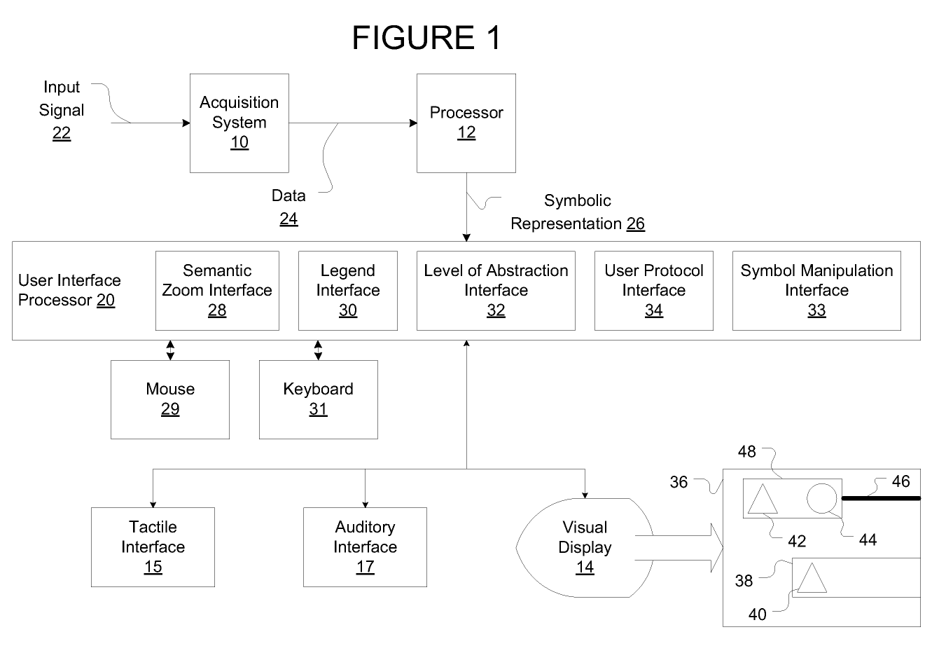

FIG. 1 is a block diagram of a test and measurement instrument providing a symbolic display of data according to an embodiment. The test and measurement instrument includes an acquisition system 10, a processor 12, a display 14, and a user interface processor 20. The acquisition system 10 is configured to receive an input signal 22. The acquisition system 10 converts the input signal 22 into data 24.

In one embodiment, the test and measurement instrument is a logic analyzer. The acquisition system 10 may be a probe and associated circuitry to sense the input signal 22 within a device under test (DUT) and convert the input signal 22 into the data 24. In another embodiment, the acquisition system 10 may include one or more processors to aid in converting the input signal 22 into the data 24. Any combination of circuitry that converts the input signal 22 into data 24 representing the input signal 22 may be an acquisition system 10.

The processor 12 is coupled to the acquisition system and is configured to generate a symbolic representation of protocol-specific information within the input signal 22. Using the logic analyzer example described above, the input signal 22 may be electronic signals on the DUT. These signals may represent data 24 embodied by the input signal 22. The data 24 may be further categorized if it complies with a protocol. Groups of the data 24 may correspond to data organizations defined by the protocol. The processor 12 may be a variety of devices. Such devices include general purpose processors, application specific integrated circuits, programmable logic devices, or the like. In addition, the processor 12 may be any combination of such devices.

Protocol-specific information is the abstraction of the data 24 according to one or more protocols. For example, a protocol may define a packet including a header and a data payload. When the data 24 is received, it may be analyzed to determine if it complies with the protocol. If so, a first portion of the data 24 corresponds to the packet. Within that first portion, a second portion corresponds to the header and a third portion corresponds to the data payload. Thus, the protocol-specific information includes information such as the existence of a packet, the existence of a header, the contents of the header, compliance of the packet with the protocol, or any other relationship between the data 24 and the protocol.

Protocol-specific information is not limited to any specific implementation or medium. For example, the protocol-specific information may be associated with a serial implementation, a parallel implementation, a combination of serial and parallel implementation, or the like. Furthermore, such protocols may be embodied in a variety of media. For example, as described above, the protocol may be embodied in serial communications between electronic components of a system. Alternatively, the protocol may be embodied in a wireless link between infrared devices. The protocol-specific information may describe communications in any implementation or media.

Although the protocol may be a single protocol, the protocol is not limited to only one protocol or any particular subset of the protocol. For example, one protocol may be encapsulated within another protocol within the data 24. Alternatively, one protocol may have a variety of layers defined for communications within the data 24. For example, a data-link layer and a transaction layer may simultaneously exist in the data 24. Any number of protocols, layers, or the like may exist within the data 24.

From the protocol-specific information, the processor 12 generates a symbolic representation. Fields, data, states, and other concepts or associations defined by the protocol are associated with the symbolic representation.

Symbols are associated with packets, headers, fields, information, states, or the like defined by the protocol. In this context, a symbol is a graphical or other abstract visual representation of the protocol-specific information. Symbols can be constructed by varying a wide variety of characteristics. Such characteristics include shape, size, in-fill, line type, line width, color, ornamentation, deformation, or the like.

The symbolic representation is a collection of symbols. The symbolic representation includes the meaning behind the individual symbols. In addition, the symbolic representation may include a representation of protocol-specific information and thus have meaning extending beyond the individual symbols themselves. For example, symbols representing packets may be displayed from right to left on a display according to the time the packets were received. Thus, through the placement of symbols in relationship to one another, the user may visually comprehend a time relationship between the packets. In particular, the distance of the positioning may be proportional to time.

A symbolic representation allows for a greater information density than other textual representation. For example, as size decreases, a symbol may retain enough identifying features to still convey the information embodied by the symbol. In contrast, for a similar decrease in size, text may become unreadable. Since symbols may be decreased in size more so than text without affecting the delivery of information, more symbols may be displayed on a given display.

The symbols and the symbolic representation as used herein are distinct from textual representation using text to convey information. When using text, a higher level of cognition is required to interpret the text that is not required to interpret the meaning of the symbols. The interpretation of symbols is performed by the “perceptual” process of a user's brain. Visual processing within the brain may be invoked without higher level cognitive functions such as language, reasoning, etc. For example, an acknowledgement packet may be represented by a symbol with a check mark. Thus, the user may see the check mark and without having to process the word “acknowledgment” or even the abbreviation “ACK”, the user is informed of the acknowledgement packet. In the symbolic representation, the use of labels, numbers, text and other elements that require cognitive processing can be minimized or eliminated altogether.

The data 24 may be interpreted to represent ASCII “symbols”. However, this “symbolic” representation is only a lower level of a textual visualization. The user must still interpret the meaning of the text formed by the ASCII symbols to obtain the information represented by the text. Thus, symbols are distinguished in that the meaning represented by the symbol can be directly interpreted from the symbol without having to interpret an intermediate meaning as with text.

The use of symbols provides several advantages. For example, as described above, the interpretation of the symbols uses a lower level of cognition that is inherent in the way we see. Patterns, errors, and other artifacts from a symbolic representation of protocol-specific information are easily distinguished from other “uninteresting data” also displayed.

In addition, differing protocols may be used within the input signal 22. The different protocols may be represented by differing symbols. Thus, relationships of data conforming to the various protocols may be displayed such that the protocols are distinguished, yet the relationships among the various protocols may still be seen.

The display 14 displays the symbolic representation. An image 36 in FIG. 1 illustrates an example of a symbolic representation of the protocol-specific information within the data 24. Geometric symbols 40 and 42 may represent the beginning of the associated transactions 38 and 48. Symbol 44 may represent an acknowledgment of a transaction 48. Line 46 may represent a relationship between the transaction 48 and an expected transaction or other data. Although one particular example has been given in FIG. 1, more detail will be provided below for other examples. Furthermore, the display 14 is not limited to the geometric symbols illustrated in the image 36.

The symbolic representation may be presented to the user in ways other than through the display 14. In one embodiment, the test and measurement instrument may also include a tactile interface 15. The tactile interface 15 is an interface that communicates using techniques associated with the sensation of touch. For example, such techniques include vibrations, movements, existence or absence of physical objects, or the like. Any physical characteristics that can be sensed through touch may be used to communicate the symbolic representation to the user.

In another embodiment, the test and measurement instrument may also include an auditory interface 17. The auditory interface 17 is an interface that communicates using techniques involving the sensation of hearing. For example, speakers, buzzers, whistles, or the like can be part of the auditory interface 17. Any device capable of generating a sound can be part of the auditory interface 17.

Although the display 14, the tactile interface 15, and the auditory interface 17 have been described separately, any combination of such devices can be part of the test and measurement instrument. For example, as illustrated in FIG. 1, the test and measurement instrument may include varieties of each type of such devices. In another example, only the auditory interface 17 may be included.

Although throughout this discussion, some presentations of symbolic representations are described in visual terms, the symbolic representations may be presented in formats appropriate to the auditory interface 17 and the tactile interface 15. For example, an error may be represented visually by a change in color. Similarly, that error may be represented audibly by a loud beep or tactilely as a vibration. As a result of using multiple senses of the user to convey information, the user may visually concentrate on one device and yet be notified through sound or touch that an event of interest has occurred, without having to periodically examine other devices.

The symbolic representation may be all symbols corresponding to the protocol-specific information, a certain level of abstraction of those symbols, a variety of abstractions of those symbols, or the like. Although a symbolic representation may include every possible symbol associated with the protocol-specific information, all of the symbols need not be part of the symbolic representation. For example, consider a first and a second protocol with the second protocol being built upon the first protocol. If the first protocol is of interest, the symbolic representation may include only symbols specific to the first protocol. Alternatively, the symbolic representation may include only symbols specific to the second protocol. Thus, the symbolic representation may include some to all of the symbols associated with the protocol-specific information.

In one embodiment, the test and measurement instrument includes a user interface processor 20 to adjust the symbolic representation. The adjustment is in response to a user input. The user interface processor 20 may receive the user input in a variety of forms. For example, the user interface processor 20 may receive input from devices such as keyboards 31, buttons, knobs, dials, sliders, computer mice 29 or the like. The user interface processor 20 can receive input from physical interfaces or virtual representations of interfaces, such as a graphical representation of a knob, button, slider, or the like.

In addition, the user interface processor 20 may communicate with a portion of the display 14. Thus, options or controls for the user interface processor 20 may be communicated to the user through the display 14. The user may provide input through devices that are related to the displayed user interface. Furthermore, the user interface processor 20 may include remote interfaces coupled to the test and measurement instrument through a communications link such as a mouse, remote control, remote workstation, or the like.

The user interface processor 20 can handle any processing, interfaces, communications, or the like between any implementations of any parts of the user interface. In one embodiment, the user interface processor 20 can handle the various presentation and human input processing tasks. In addition, the user interface processor 20 can handle communications between the user interface and any other devices of the test and measurement instrument. For example, the user interface processor 20 may act as the interface to the display 14, the tactile interface 15, and the auditory interface 17. Furthermore, although illustrated as distinct from the processor 12, the user interface processor 20 and the processor 12 can include parts of the same device, including distinct and common parts.

In one embodiment, the user interface processor 20 includes a semantic zoom interface 28. The semantic zoom interface 28 is configured to adjust a level of information detail of the symbolic representation in response to the user input. There may be a variety of levels of information detail within the data 24. By manipulating the semantic zoom interface 28, the level of information detail that is displayed may be changed.

In another embodiment, the user interface processor 20 includes a legend interface 30. Although symbols have several advantages over a textual representation, a user may not understand the meaning behind each symbol. Even if a user understands all of the symbols, additional information may be obtained by highlighting particular symbols.

In one embodiment, the legend interface 30 is configured to adjust the symbolic representation in response to a selection of an icon of the legend interface through the user input such that symbols of the symbolic representation that match the selected icon of the legend interface are highlighted.

The legend interface 30 may allow selection of a symbol. By selecting the symbol, the displayed symbolic representation may be updated to highlight the selected symbol. Highlighting as used herein is any modification that draws the user's attention to the selected symbols in the displayed symbolic representation. For example, highlighting may be a change in size, color, shape, etc. Highlighting may also be an adornment. Highlighting may be a dynamically changing attribute such as a changing color, or a flashing adomment. Any change in a symbol that draws the user's attention to the symbol may be highlighting.

In addition, the legend interface 30 may provide information on the symbols used in the symbolic representation. If a symbol appears in the displayed symbolic representation, that symbol appears in the legend interface 30. Not only may the user see the symbols used in the displayed symbolic representation, a user may also interrogate the symbols to obtain information regarding the symbols themselves, particular associations of symbols, meaning behind the symbols, or any other information related to a symbol in the legend interface 30.

The user interface processor 20 may also include level of abstraction interface 32. The level of abstraction interface 32 is configured to adjust an abstraction range of the displayed portion of the symbolic representation. As described above, varying levels of abstraction may be represented in the symbolic representation. The level of abstraction interface 32 provides an interface for the user to indicate a desired abstraction range. For example, if a user is interested only in a data link layer protocol, the user may limit the level of abstraction to eliminate symbols associated with a transaction layer protocol. Thus, the user may interrogate the data 24 at the level of the data-link layer protocol.

A range of levels of abstraction may, but need not be continuous. For example, consider data 24 complying with a protocol with three layers, with each layer building off of the next. The range of level of abstractions may include the first layer and the third layer with the second layer not represented. Thus, the range of the levels of abstraction can have a gap where the abstraction level of the second layer is not included.

In another embodiment, the user interface processor 20 includes a user protocol interface 34. Users may use unique, proprietary, or otherwise uncommon protocols in the implementation of the DUT. The test and measurement instrument may be configured with associations of standardized protocols. However, if the user is using an uncommon protocol, a protocol that is not configured on the instrument, a standardized protocol with user modifications, or the like, the user may input the association of the user protocol and user-defined symbolic grammar through the user protocol interface 34. The processor 12 adjusts the symbolic representation according to the user-defined symbolic grammar. Thus, the symbolic representation includes symbols associated with the protocol-specific information according to the user protocol.

The user interface processor 20 may also include a symbol manipulation interface 33. The symbol manipulation interface 33 is coupled to the processor 12 and configured to adjust protocol-specific information associated with a selected symbol in response to the user input. Thus, a user may select a symbol and manipulate attributes of the symbol, including the associated protocol-specific information, the symbol grammar that resulted in the selection of the symbol; associate the protocol-specific information associated with that symbol with another symbol grammar; or any other action that relates to information associated with the symbol.

Although particular connections have been described between components of the test and measurement instrument, any one or all of the components can be coupled through communications links. For example, the acquisition system 10 and the processor 12 may be in the same location as a device-under-test. However, symbolic representation 26 may be communicated over a communications link, such as a computer network, to the user interface processor 20. Any distributed placement of components can be implemented.

In addition, although the user interface processor 20 has been described as including a variety of interfaces such as the symbol manipulation interface 33, the legend interface 30 or the like, the user interface processor and the included interfaces can be integrated, distinct, or a combination of both. For example, the semantic zoom interface 28 may be a distinct device coupled to a port on the user interface processor 20. Accordingly, the user interface processor 20 is not limited to only processing functions, but may also include devices, structures, components, or the like that perform no processing.

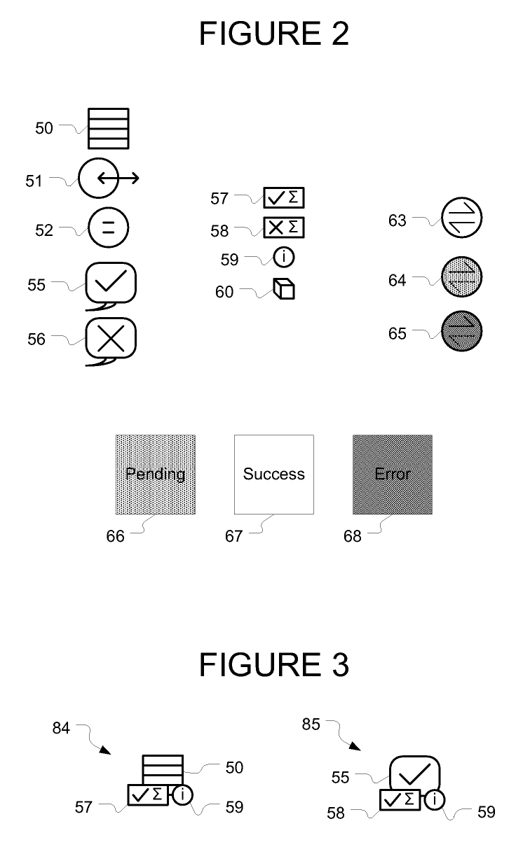

FIG. 2 is an example of a symbol grammar for a symbolic representation according to an embodiment of the invention. A symbol grammar is an association of protocol-specific information to symbols. A symbol may be associated with any information contained within a protocol. Symbols may be formed using a variety of visual, auditory, and tactile elements. For example, location, shading, infill, color, ornamentation, shape, line characteristics, orientation, deformation, or any such visual aspect may distinguish one symbol from another. It should be noted that the drawings are rendered in black and white. As a result, the illustration of color has been replaced with an infill. However, even though not particularly illustrated, color and infill are distinct and may be separately or simultaneously used in the same or varying aspects.

For example, a particular symbol may be associated with a type of transaction. Symbols 50-52, and 55-56 are examples of symbols indicating a transaction type. Symbol 50 indicates a memory transaction. Symbol 51 indicates an input/output (I/O) transaction. Symbol 52 indicates a configuration transaction. Symbols 55 and 56 represent replies for transactions. Symbol 55 is an acknowledged reply. Symbol 56 is a not-acknowledged reply. Any type of transaction may be represented by a symbol.

As described, a symbol may be modified by an adorning symbol. Symbols 57-60 illustrate examples of adorning symbols. Symbols 57-60 may be symbols in their own right, however, in this example, they are used as adornment. In some protocols, a packet may have a checksum field. The checksum is used in ensuring integrity of the packet. At some point, the packet is verified using the checksum. Symbols 57 and 58 are associated with a successful and unsuccessful checksum, respectively. Thus, according to the outcome of verifying the checksum, an adorning symbol such as symbols 57 and 58 may be added to the symbol for the packet.

The checksum illustrates a possible scope of the protocol-specific information. When received as data, the checksum may only be a number within a packet. However, beyond the number is the concept of whether the packet is verified by the checksum. The information on the verification is not indicated by the checksum value itself, but by the association of the packet and the checksum. Thus, the protocol-specific information includes not only the explicit information embodied in the data, but also information that may be derived from that data.

Symbols 59 and 60 indicate an existence of particular data forms within a packet. Symbol 59 indicates the presence of information such as a command or other request. Symbol 60 indicates the presence of a payload or data within the context of a particular protocol.

Symbols 66-68 illustrate the association of color, shading, infill, or other attribute of a symbol that conveys information. In this example, symbol 66 indicates a pending state, symbol 67 indicates a success state, and symbol 68 indicates an error state. Thus, with the same shape of symbol, another attribute, such as color, shading, infill, or the like, may convey additional information.

Symbols 63-65 illustrate another example. Symbols 63-65 illustrate a status of an association of protocol-specific information. In this case, the symbols 63-65 illustrate a state of a relationship of one transaction to another. Symbol 63 indicates a successful transaction association. Symbol 64 indicates a pending or incomplete association. Symbol 65 indicates an errored transaction association. Both symbols 64 and 65 include a different line style from the successful transaction symbol 63. The change in line style indicates an incomplete transaction. In addition, both symbols 64 and 65 include additional attributes such as the color or infill described for symbols 66 and 68. Although each aspect of a symbol may convey unique protocol-specific information, multiple aspects may convey the same information.

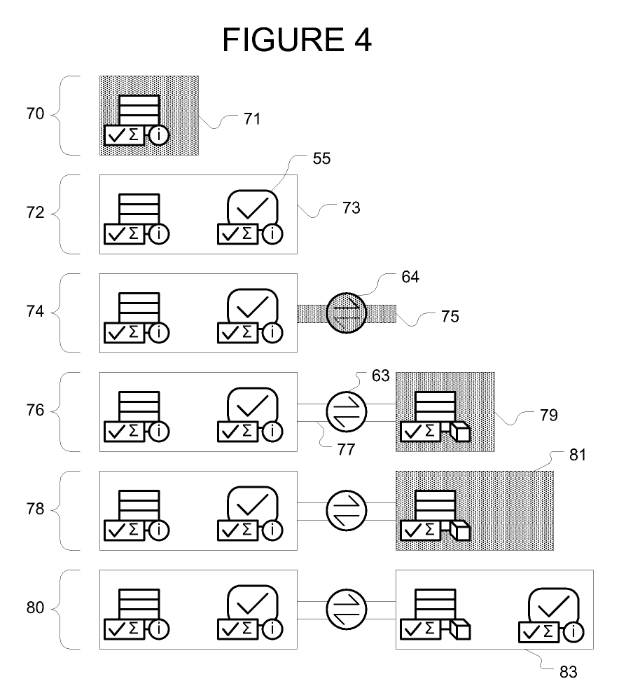

FIG. 3 is an example of adornment of symbols of FIG. 2. Adornment is the decorating of a base symbol with an adorning symbol. Both the base symbol and the adorning symbol may be any symbol. Furthermore, any symbol, including a symbol with adornments may become an adornment for another symbol.

The adorning symbol provides additional information concerning the base symbol. Symbol 84 includes the memory transaction symbol 50 as a base symbol. It is modified by the successful checksum symbol 57 and the information present symbol 59 as adorning symbols. Similarly, symbol 85 includes the transaction acknowledged symbol 55 modified by the unsuccessful checksum symbol 58 and the information present symbol 59.

Adorning symbols may convey a variety of information. The adorning symbol may indicate a type of packet, a directional flow of information, a presence of a payload, success of a checksum, or any other aspect of the protocol-specific information associated with the base symbol.

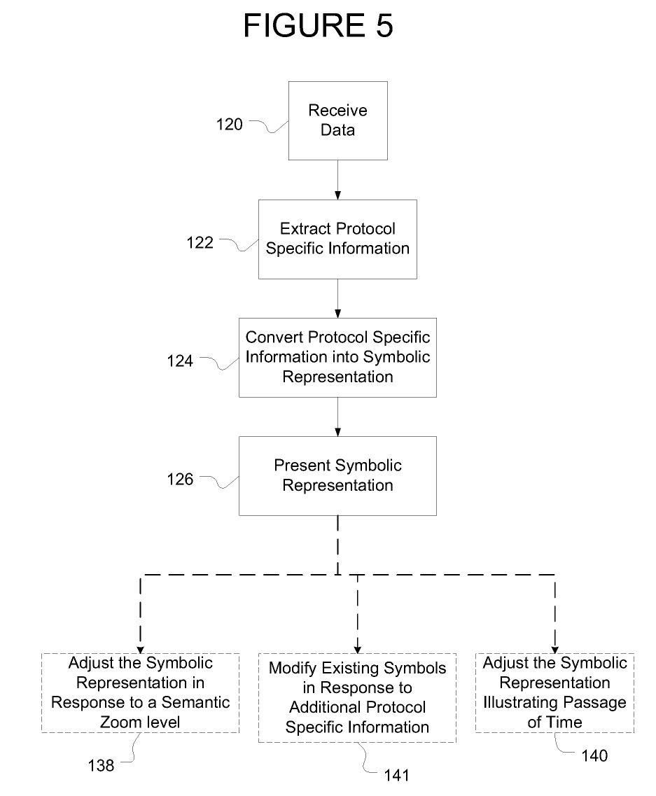

FIG. 4 is an example of a symbolic display of various states of a split-pair transaction using the symbol grammar of FIG. 2. The split-pair transaction illustrated in FIG. 4 is an example of a split-pair transaction. Such split-pair transactions may or may not exist, or may take alternate forms in any given protocol. As described above, associations between protocol-specific information may result in symbols describing the relationship. In FIG. 4 and the following description, reference numerals for previously-described symbols are omitted for clarity.

In symbol set 70, a memory transaction symbol indicates a start of the transaction. The packet associated with the start of the memory transaction has a verified checksum and an indication that it contains information. In this example, the memory transaction may be a request for data. The symbol 71 is a container indicating the expectation of some form of acknowledgement to complete the transaction. Thus, the memory transaction packet may be complete and its checksum is verified, however, with knowledge of the protocol, a response is expected. Similar to the symbols 66 of FIG. 3, the symbol 71 indicates that the transaction is still pending.

In symbol set 72, an acknowledgment has been received. The acknowledgement is represented by the symbol 55. The checksum of the acknowledgment is verified and the acknowledgment contains information, not data. A symbol 73 in the form of a box around the memory transaction symbol and the acknowledged symbol 55 identify the relationship of the two symbols. Thus, with a glance, a user may see the memory transaction, follow the symbol 73 indicating the association, and find the acknowledgment at the end. In addition, the user need not even recognize the memory or acknowledged symbols 55. The infill may indicate the success. In this case symbol 73 has the same color as the symbol 67 of FIG. 3, indicating success.

Symbol set 74 illustrates the association of the protocol-specific information illustrated in the symbol set 72 to expected related protocol-specific information. In this example, the expected related protocol-specific information is a transaction with the data requested by the memory transaction. Symbol 75 indicates this expectation. Again, the symbol 75 has a color of the symbol 66 indicating that the response to the memory transaction is still pending. In addition the symbol 64 is added to indicate the expected transaction.

Symbol set 76 illustrates the change of symbols 75 and 64, which indicate the expectance of a transaction, into symbols 63 and 77, which indicate the successful reception of the related protocol-specific information representing the expected transaction. Symbol 79 indicates that the second transaction is not yet acknowledged and is thus still pending. In addition, comparing the memory transaction symbols of the first transaction and the second transaction, the second transaction has a payload ornament as illustrated in FIG. 2. Thus, the user is informed of the contents of the packet.

In this example, the symbols 77 and 63 indicate success before the success of the entire split-pair transaction with the pendency being shifted to the unacknowledged transaction symbol 79. However, the success could be illustrated with any desired degree of granularity. For example, the entire symbol set representing the state of the split-pair transaction may be colored to indicate pendency until the last remaining requirement for success is received. Alternatively, as each portion that may be individually interpreted as being successful itself is interpreted as successful, the symbol for that portion may be modified to indicate the success.

Symbol set 78 illustrates another aspect of a symbol that may be used to illustrate information within the protocol-specific information. In this case, time has passed while waiting for an acknowledgement. Symbol 81 is lengthened relative to symbol 79, visually representing the time that has passed waiting for the acknowledgment. Thus, the symbol 81 was deformed and the deformation provides additional information.

Any symbol may be modified to illustrate the time over which the data associated with that symbol is received. For example, the pending transaction association represented by symbol 75 may have a variable horizontal length that is defined by the time between the acknowledgement of the first transaction and the memory transaction of the second transaction of the split-pair transaction. Thus, as time passes, the horizontal length may be increased to illustrate the passage of time.

Symbol set 80 illustrates the complete split-pair transaction after the acknowledgment of the second transaction is received. Since the split-pair transaction was successful, the entire symbol set 80 has the infill indicating success.

Although particular symbols, arrangement of symbols, associations of symbols and meanings, and other aspects of examples of a symbol grammar have been described, other symbol grammars may be used. Other symbols may be chosen to illustrate the protocol-specific information.

Users commonly look for errors when debugging circuits or systems. Indications of the errors help the user focus on portions of the data that may lead to the source of the problem. Through an appropriate grammatical construct (deformation, ornamentation, color, pattern, infill, shape), errors can be displayed including information such as severity, source (protocol layer), or the like. As a result, the user can more quickly identify information concerning the error. For example, in some protocols, several attempts at a transaction must fail before the transaction itself is reported as a failure. Thus, the failed attempts may be illustrated with a lighter color indicating a failed attempt, and the failed transaction due to multiple failed attempts may be illustrated by a darker color. Similarly, the degree of failure may be represented by a sound or tactile sensation of increasing volume or intensity.

Although grammars have been described as having any association, attributes, or the like, particular embodiments include specific associations for symbol grammar that improve the conveyance of information. In one example, the symbols for a particular protocol are selected such that various layers within the protocol are easily distinguishable. The distinction of layers may be accomplished by using widely varying symbols for the different layers. Thus, when a user views multiple layers at one time, the user may easily distinguish between the layers.

Symbols representing information from a particular layer of a protocol may have a common unifying attribute. For example, the unifying attribute may be a similar color, shape, adornment, or the like. Any attribute of the symbols can be used to unify the symbol set of that layer such that a user will understand that the symbols represent that particular layer.

To distinguish symbols for one layer from symbols for another layer, the unifying attributes of the layers may be selected to be easily distinguishable. For example, as described above, a border such as the box 73 of symbol set 72 of FIG. 4 indicates a transaction for a particular layer of a protocol. To distinguish another layer, the border may have a different shape, line style, infill, or the like. For example, the ends of the border may be semicircles. Thus, without having to examine a field or read text, the user is made aware that a different layer is represented.

In addition, protocols or layers may be differentiated by patterning or clustering of symbols. Since protocols or layers may have differing relationships of symbols, the patterning or clustering of the symbols may result from the display of the relationship of the symbols. Alternatively, the patterning or clustering of the symbols may be induced in the display of the symbols to differentiate the layers.

Although layers may be distinguished from one another, consistency can be maintained between similar elements among the layers. For example, two layers may each have an “acknowledgement” packet represented by corresponding symbols. As a result, similar concepts among the layer may be illustrated by using similar symbols for both acknowledgement packets. Accordingly, the user need not learn a completely different symbol set for a different layer.

Furthermore, the symbols for the similar elements within the layers may, but need not be identical. For example, the symbol for an acknowledgement for a first layer may be formed from a base acknowledgement symbol with an ornament specific to the first layer. Similarly, the symbol for an acknowledgment for a second layer may be formed from the same base acknowledgment symbol, but with an ornament specific to the second layer. Thus, the symbols for the first and second layers are both similar in that they are formed from the same base symbol, yet are different as a result of the layer specific adornment.

Furthermore, although differing layers in a protocol have been described as being differentiated, differing protocols may be distinguished by different symbols.

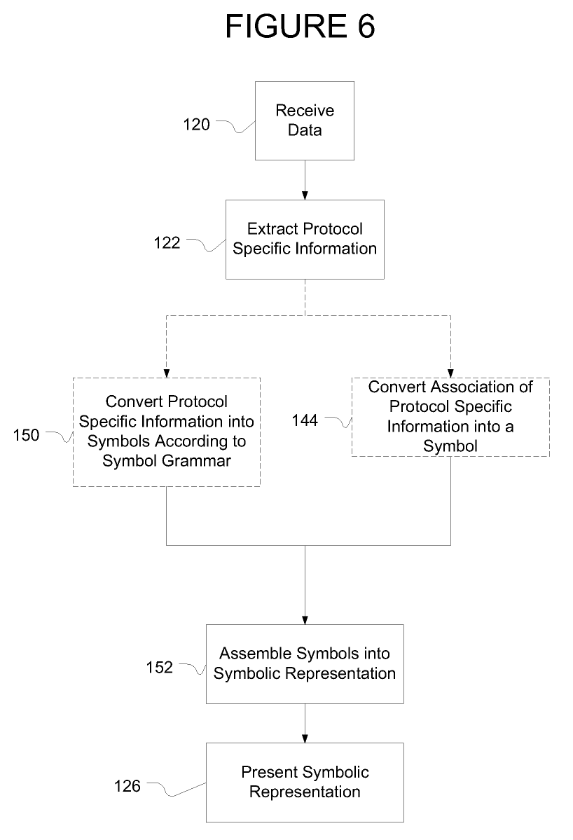

FIG. 5 is a flowchart illustrating a method of displaying a symbolic representation of data according to an embodiment of the invention. An embodiment includes a method of displaying data. The data is received in 120. From the data, protocol-specific information is deextracted in 122. The protocol-specific information is converted into a symbolic representation. The symbolic representation is presented in 126.

Receiving the data in 120 may include receiving the data from a variety of sources. For example, a probe may receive signals from a DUT. The probe converts the signals into data. Alternatively, the data may be stored. Receiving the data may include reading the data from the file. Thus, receiving the data may include any variety of techniques for getting the data into a state to be further processed.

Extracting the protocol-specific information may be performed in a variety of ways. Pattern-matching algorithms, data parsers, or the like may interpret the data to determine if the data corresponds to a particular protocol. If so, protocol-specific information is extracted by the algorithm or parser. For example, headers, flags, states, or the like may all be extracted as protocol-specific information.

Extracting the protocol-specific information may also include interpreting the data or the currently-extracted protocol-specific information to generate additional protocol-specific information. For example, if a first packet is received describing a start of a transaction, yet a second packet indicating the end of the transaction has not been received, the additional protocol-specific information that is extracted is the expectancy of the second packet. In another example, the second packet may not be received in a time period specified by the protocol. Since the second packet was not received, it did not exist in the data. However, from the time that passed from the receipt of the first packet and the protocol-definition time period, the unsuccessful reception may become part of the protocol-specific information. Thus, extracting the protocol-specific information in 122 is more than just the data within packets or other groupings according to the protocol. Extracting the protocol-specific information in 122 also includes information that is interpreted from the data itself Accordingly, any definition, state, result, status, or the like defined by the protocol, regardless of whether it is explicitly present in the data, may become part of the protocol-specific information.

In one embodiment, a method of displaying a symbolic representation of data according to an embodiment can include adjusting the symbolic representation to illustrate the passage of time 140. Adjusting the symbolic representation to illustrate the passage of time 140 includes a variety of changes to the symbolic representation.

In another embodiment, a method of displaying a symbolic representation of data according to an embodiment can include modifying existing symbols of the symbolic representation of the protocol-specific information in response to additional protocol-specific information 141.

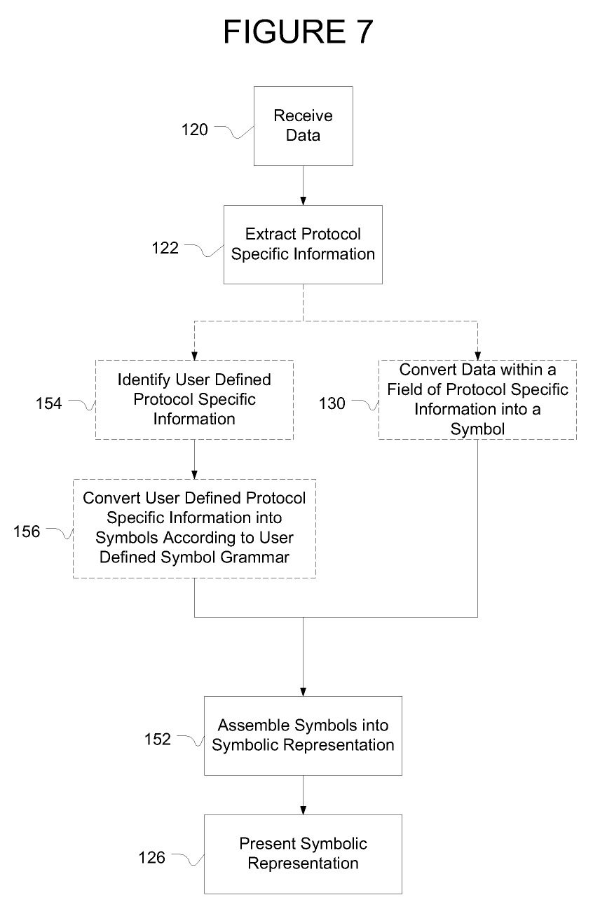

FIG. 6 is a flowchart illustrating a method of displaying a symbolic representation of data according to another embodiment of the invention. Converting the protocol-specific information in 124 of FIG. 5 into the symbolic representation results in a representation of the protocol-specific information such that the information is conveyed through the symbolic representation. In one example, of converting the protocol-specific information in 124, the protocol-specific information is converted into symbols according to a symbol grammar in 150. As described above, a symbol grammar associates protocol-specific information with a symbol. Thus, once the protocol-specific information is extracted from the data, it can be converted into symbols. Once converted into symbols, the symbols are assembled into the symbolic representation in 152. Thus, the symbolic representation is the protocol-specific information represented by symbols.

As described above, the protocol-specific information may indicate a relationship within the protocol-specific information. For example, the protocol-specific information may indicate an association of a first part of the protocol-specific information such as a message packet to a second part of the protocol-specific information such as an acknowledgment packet. Since the acknowledgment packet was acknowledging the message packet, there is an association between the two packets. This association may be converted into a symbol in 144. Thus, when the protocol-specific information is converted into symbols, the association is converted into a symbol.

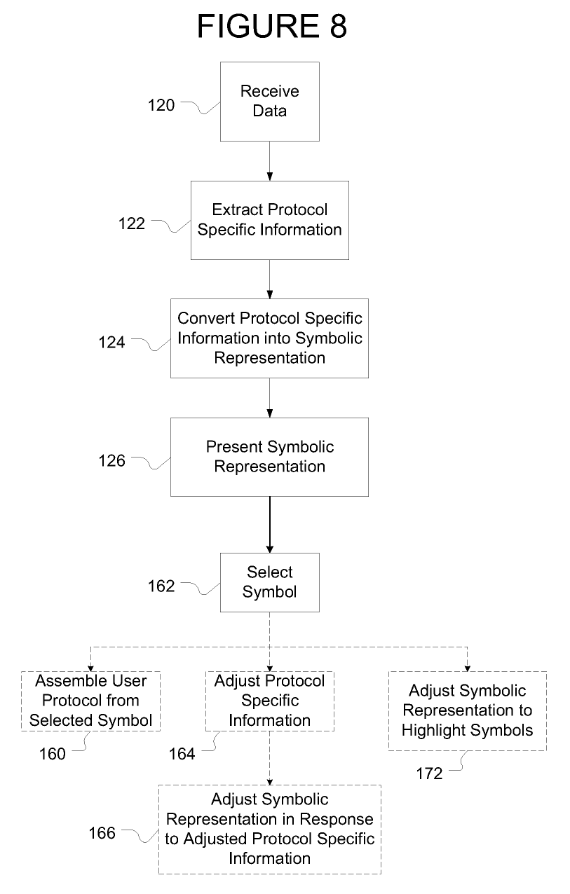

FIG. 7 is a flowchart illustrating a method of displaying a symbolic representation of data according to another embodiment of the invention. The protocol-specific information may also indicate data within a field according to particular protocol. The data within the field may be converted into a symbol in 130. A protocol may define fields in a header, for example. Each field has a particular meaning. The data in the field is converted into a symbol to convey the meaning. For example, a flag indicating a type of packet or a particular message in the packet is contained within a field of the packet. A symbol associated with the flag may be added to the symbolic representation.

As described above, a user may define a user protocol. The user-defined protocol may have its own symbol grammar. Within the protocol-specific information may be user-defined protocol-specific information. The user-defined protocol-specific information is identified in 154. The user-defined protocol-specific information identifies type, structure, relationships, headers, fields, or any other aspect of the user protocol. In addition, the user-defined protocol-specific information is not limited to intra-user protocol information. The user-defined protocol-specific information also includes relationships with any other protocol-specific information. The user-defined protocol-specific information is converted into symbols in 156.

A user-defined protocol may, but need not be entirely unique. For example, the user-defined protocol may be based on an existing protocol with some modifications. Furthermore, the user-defined protocol may be a standardized protocol that is not currently defined for the protocol-specific information. For example, multiple data-link layer protocols may be defined for the protocol-specific information. However, in one example, no transport-layer protocols may be defined even though standardized transport-layer protocols exist. If a user wants a symbolic representation according to the transport-layer protocol, the user may establish a user protocol and user-defined symbol grammar for the standardized transport-layer protocol.

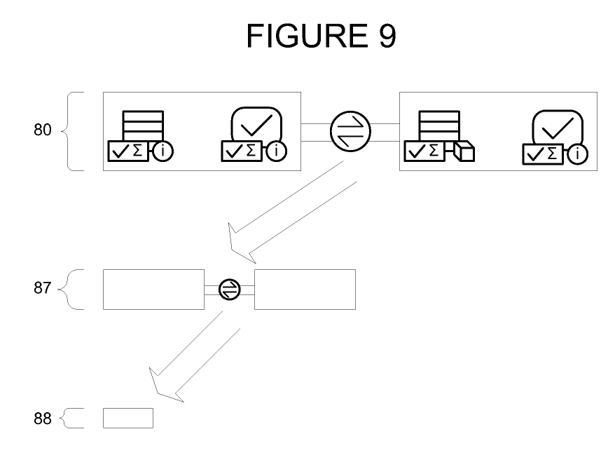

FIG. 8 is a flowchart illustrating a method of displaying a symbolic representation of data according to another embodiment of the invention. Creating a user-defined protocol may be accomplished using an existing symbolic representation. For example, a user may obtain a symbolic representation of some data.

From that symbolic representation, the user may select some existing symbols in 162. Thus, the symbol is selected in response to a user input in 162. The user input may be any variety of user interaction. For example, a user may manipulate a pointing device such as a mouse or a light pen, press a button or key, or give any other input that indicates the symbol to be selected.

Although in this embodiment, selection of a symbol has been described as being in response to the user, the selection of a symbol in 162 may be in response to inputs other than user inputs. For example, an automated input from another test and measurement instrument can be used to select the symbol. The symbol may be selected in response to a program running on the test and measurement instrument. Any such input may be used to select a symbol.

From the selected symbols, the user may assemble a user-defined protocol in 160. Such assembly may include creating an association or a symbol grammar linking the symbols. For example, an existing protocol defines packet structure. However, no inter-packet relationships are defined. By selecting the packets that are related in the user protocol, the user creates the relationship and associates a symbol for the relationship. Thus, when the user-defined symbolic grammar is used to convert the protocol-specific information into symbols, symbols representing the previously undefined relationships may be illustrated through the symbolic representation of the user-defined protocol-specific information.

Presenting the symbolic representation in 126 includes any technique for presenting information to a user. As described above, a variety of senses may be involved in communicating information to the user. For example, the symbolic representation may be displayed on a monitor or other viewing device. In another example, the symbolic representation may be sent over a communications link to a remote location. At the remote location, the symbolic representation is then displayed. The symbolic representation may be communicated auditorily to the user. The symbolic representation may be communicated tactilely to the user. Thus, presenting the symbolic representation in 126 may include displaying the symbolic representation, auditorily presenting the symbolic representation, tactilely presenting the symbolic representation, or any combination of such presentation techniques.

Referring to FIG. 5, a method of displaying a symbolic representation of data according to an embodiment can include adjusting the symbolic representation in response to the semantic zoom level in 138. Adjusting the symbolic representation in response to the semantic zoom level in 138 includes a variety of changes to the symbolic representation.

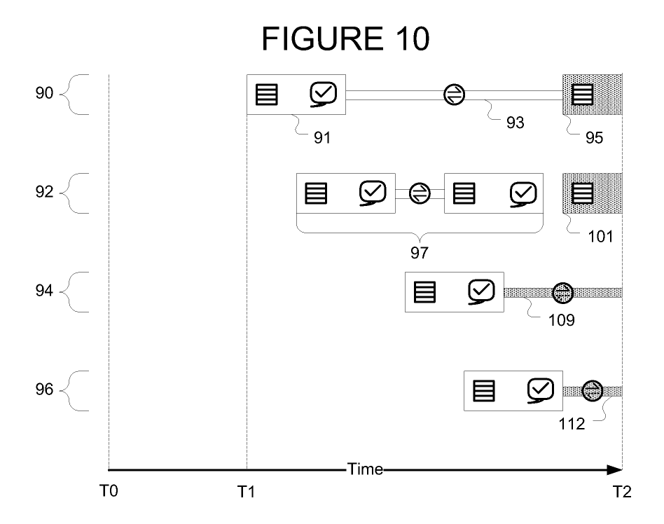

FIG. 9 is an example of different semantic zoom levels of a symbolic display according to an embodiment of the invention. Semantic zooming is a technique of displaying varying levels of detail in contrast to a scaled zoom that merely changes the size of the displayed object. To accomplish this, a semantic zoom level is adjusted. In response to the semantic zoom level, the symbolic representation is adjusted.

Symbol set 80 is an example of a symbolic representation of a split-pair transaction described above in FIG. 4. As can be seen, multiple additional symbols within each of the transactions and the relationship of the transactions may be seen. When changing the semantic zoom level, the level of information detail is changed. For example, symbol set 87 is a representation of symbol set 80 at a different level of information detail. The transactions and the relationship of the transactions can still be seen, however, the individual symbols within the transaction are removed. In symbol set 88, the split-pair transaction has been reduced to a single symbol.

Thus, this example illustrates an example of the change in level of information detail due to semantic zooming. When zooming in, additional information can be added into symbols, until ultimately the symbol can be broken apart and additional symbols for its constituents can then be displayed.

Semantic zooming is not limited to within one particular protocol or layer of a protocol. For example, the protocol-specific information may include higher level transport-layer packets and lower level data-link layer packets. At a high level of semantic zoom, only the existence of the transport layer packets may be displayed as symbols. Then through varying degrees of additional or modified symbols, the level of information detail may be increased until the fields, headers, or the like of the data-link layer packets are represented as symbols as well. Any level of information detail may be displayed with an associated semantic zoom level.

Thus, in one embodiment, semantic zooming includes replacing a first set of symbols of the symbolic representation with a second set of symbols. The second set is different from the first set such that a level of information detail of the first set of symbols is different from a level of information detail in the second set of symbols. An example of the difference in level of information detail is illustrated in the difference between symbol sets 80, 87, and 88. More symbols and modifications to the symbols are displayed when increasing the level of information detail in the symbolic representation through semantic zooming.

Level of information detail is distinguished from level of detail. The level of information detail describes the amount of information represented. In contrast, level of detail can be any change in detail, including only scaled zooming. In addition, semantic zooming as used herein is distinguished from a presentation of additional information known as detail on demand. Typically, in detail on demand the original representation remains and additional information is added. In contrast, in semantic zoom, the original representation is replaced with another representation including more information.

Although semantic zooming has been described, scaled zooming may also be used. In particular, the symbolic representation is capable of conveying information over a wider range of scaled zoom levels as compared to a textual representation. As the size of text decreases, the identifying features of the text diminish until it is difficult to interpret. In contrast, symbols of a symbolic representation may still be interpreted at the same scaled zoom levels where text becomes indecipherable. For example, if an error within a packet is represented by text such as “Error”, as the size of the text decreases, it becomes more difficult to interpret. However, if the symbol for the packet is shaded or colored, for example to indicate the error, that shading or coloring is still discemable after the text becomes unreadable. Thus, a user may use a scaled zoom to display a symbolic representation beyond the scaled zoom level at which the textual display is difficult to interpret.

In one embodiment, the display of the symbolic representation maintains a relatively constant level of information density at all scaled zoom levels. When zooming out, display can reduce the size of each symbol without losing significant information while at the same time increasing the number of symbols displayed on screen. Because the symbolic representation relies on symbols rather than text as a means of distinguishing one packet from another, symbols can be reduced to a few pixels before they become indistinguishable. This is feasible even with small symbols because color, infill, orientation, or any of the above described modifications to symbols may still be used as differentiators.

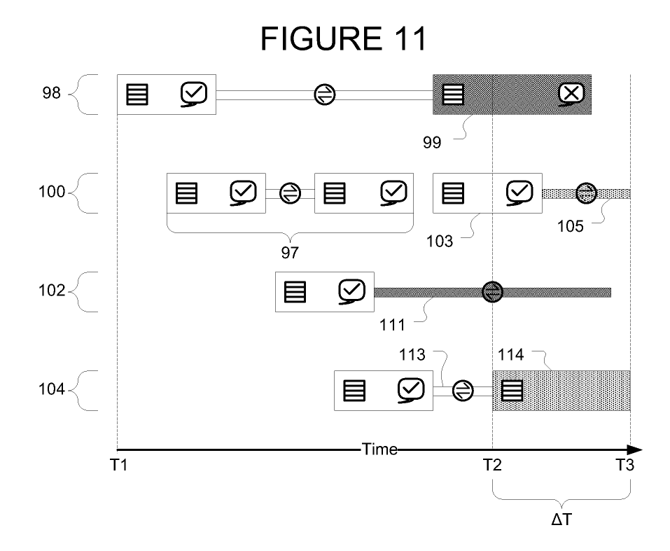

FIGS. 10 and 11 are an illustration of a passage of time and a formation of transactions in a symbolic representation according to an embodiment of the invention. FIG. 10 illustrates a state of the symbolic representation at a first time.

As described above, visual position may be used to communicate the relationships among symbols. In one example, the visual relationship may communicate time. Several times, are illustrated. Time T0 represents a time when there are no pending transactions. At time T1, a first transaction 92 in line 90 has begun. The first transaction 91 is displayed in one position. A symbol 93 for a split-pair association is illustrated as extending horizontally until an incomplete transaction 95 is displayed. The length of the symbol 93 illustrates the time between when the transaction 91 ended and the incomplete transaction 95 began.

FIG. 10 also illustrates the relationship between unrelated groups of protocol-specific information. In line 92, another split-pair transaction 97 is illustrated. As can be seen, the transactions forming the split-pair transaction 97 occurred before the incomplete transaction 95 in line 90 began. Thus, through a simple inspection, the user can see that the time relationship of the split-pair transaction 97 and the split-pair transaction in line 90.

Thus, in one embodiment, along a first axis, the symbolic representation of related protocol-specific information is displayed. In the example in line 90, it is the protocol-specific information representing a single split-pair transaction that is the related protocol-specific information. Along another axis, unrelated protocol-specific information is displayed. The unrelated protocol-specific information is the other split-pair transaction 97 of line 92. As can be seen in FIG. 10, the split-pair transaction 97 is vertically offset from the split-pair transaction in line 90. Thus, orientation of the symbols of the symbolic representation can convey additional protocol-specific information beyond time.

Time T2 illustrates a point in time at which the states of some transactions are not known. For example, transactions 95 and 101, and links 109 and 112 are illustrated as extending to time T2 to illustrate uncertainty.

As a result of such visual position representing time, the correlation of protocol-specific information in time is easily interpreted. If time is displayed with a textual time stamp, the user must not only read the time, but also use mathematical operations to determine relative time. In contrast, the location of the symbols, the deformation of the symbols, and other changes to the symbols may convey time such that the relationship between symbols, and consequently the associated protocol-specific information is readily apparent by visual inspection. In addition, measuring time differences between events of interest becomes a straightforward activity of placing marks. In addition, when multiple protocols are displayed on the same screen, the display provides a user with a time correlation between the symbols of the multiple protocols.

In addition, related protocol-specific information may appear closely related in time. For example, a data transfer may include multiple related split-pair transactions. Thus, when displayed similarly as described above, the symbols for the group of related protocol-specific information is visually clustered together. As a result, a user may easily manipulate the entire group. For example, a user may select a successfully completed group of symbols for deletion to remove clutter from the display.

FIGS. 10 and 11 also illustrate adjusting the symbolic representation to illustrate the passage of time. In particular, FIG. 11 illustrates a state of the symbolic representation at a second time after a time ΔT has passed. Time may be represented in many aspects of the symbolic representation. As described above, within a static symbolic representation including lines 90, 92, 94, and 96 of FIG. 10, time is represented on one axis.

Referring to FIG. 11, the symbolic representation may be adjusted to illustrate the passage of time. Lines 98, 100, 102, and 104 correspond to lines 90, 92, 94, and 96 of FIG. 10 after the passage of time ΔT. As can be seen, for example, the split-pair transaction 97 of line 100 has moved relative to the split-pair transaction 97 of line 92 of FIG. 10. Thus, the movement illustrates the passage of time.

The passage of time also may result in the acquisition of new data. The adjustment of the symbolic representation may include adjusting the symbols according to the new data. FIG. 11 also illustrates this aspect of the passage of time. Transaction 99 of line 98 is different from transaction 95 of line 90 of FIG. 10 in that the infill is different. In this example, the infill corresponds to a state of acknowledgment of a response of the transaction. At the time represented in line 90 of FIG. 10, the data indicating that an acknowledgment had not been received and the transaction is still pending. In line 98 of FIG. 11, the non-acknowledgment was received. Transaction 99 has additional symbols and a different infill to distinguish the change due to newly acquired data. In addition, transaction 99 was extended horizontally to indicate the passage of time before the non-acknowledgement was received.

Line 92 of FIG. 10 illustrates an incomplete transaction 101. As time passes in line 100 in FIG. 11, the transaction 103 is successfully completed and its infill is correspondingly changed. In addition, the transaction 103 has extended horizontally beyond time T2, indicating when the acknowledgment for the transaction was received. Furthermore, in this example, the completed transaction 103 leads to the expectancy of a split-pair transaction. Thus, the link 105 illustrates the expectancy of the second half of the split-pair-transaction.

Line 94 of FIG. 10 illustrates a link 109 showing the pending status of an expectancy of a second half of a split-pair transaction. After the passage of time, in FIG. 11, in this case a sufficient time for a time-out to occur, the link 109 is adjusted into the link 111, extending its length to beyond time T2, to illustrate the failed status of the link.

Line 96 of FIG. 10 illustrates a link 112 showing the expectancy of a second half of a split-pair transaction. In line 104 of FIG. 11, the second half of the split-pair transaction is received, thus the link 112 becomes the link 113 illustrating the successful reception of the start of the second half. However, the second half 114 is illustrated as pending since an acknowledgment has not been received.

Similar to time T2 in FIG. 10, time T3 in FIG. 11 illustrates the time at which the states of some transactions are not known. As can be seen by comparing the ends of lines 98 and 102 and the ends of lines 100 and 104, symbols of lines 100 and 104 extend to time T3. Thus, by glancing at an end of the symbolic representation, the user may quickly gain an understanding of which transactions are still pending and which are resolved.

Thus, not only may time be indicated through positioning, time may also be indicated through the development of the symbolic representation. As additional data is received, new protocol-specific information may be extracted. Symbols having a relationship to the new protocol-specific information are updated to convey the new protocol-specific information to the user. For example, the symbol for the pending transaction 95 of line 90 changed into the symbol for the not-acknowledged transaction 99 after receiving a not-acknowledged packet.

Although the additional data has been described as newly received, that data may have been received or acquired at an earlier time. For example, a set of data may be acquired at an earlier time and stored to be analyzed later. By moving through the previously acquired data in the order it was acquired, the user can see the development of the symbols as if new data is acquired. As a result, a user may navigate back and forth through the data, and the symbolic representation is correspondingly adjusted.

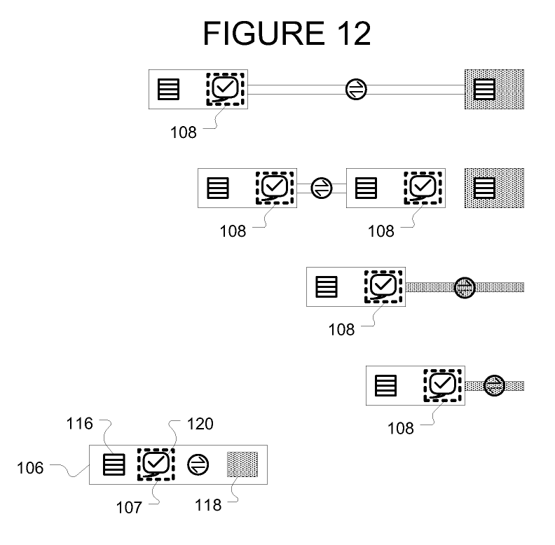

FIG. 12 shows an example of a legend for a symbolic representation according to an embodiment of the invention. Similar to FIG. 10, a symbolic representation of protocol-specific information is displayed. However, the display includes a legend 106. The legend includes symbols that are used in the symbolic representation. In this example, a message symbol 116, an acknowledged symbol 120, and the pending infill symbol 118 are displayed in the legend 106. Any symbol, including a symbol used to modify an existing symbol, may be included in the legend 106. In addition, as new protocol-specific information and corresponding symbols are added to the symbolic representation, additional symbols may be added to the legend 106. Thus, the legend 106 may be a dynamic illustration of the current symbols used in the symbolic representation.

FIG. 12 also illustrates a user interaction with the legend. The user may select a symbol in the legend 106. In response, the selected symbol is highlighted in the symbolic display. For example, a dashed line 107 is displayed around the selected acknowledged symbol 120 in the legend 106. Consequently, a dashed line 108 is displayed around the selected acknowledged symbol 120 as it appears in the displayed symbolic representation.

Although symbols appearing in the legend 106 have been described as a single symbol, a symbol in the legend 106 may be a combination of symbols as described above. For example, a base symbol may be modified with several ornamental symbols. The combination of the base and ornamental symbols may form a single symbol in the legend 106. Furthermore, any such additional symbols may also be individually represented or used in other combinations in the legend 106.

Furthermore, the legend 106 may display additional information concerning the symbols in the legend 106. For example, statistical information such as a number of instances of a particular symbol currently displayed may be added to that symbol in the legend 106. In addition, any such information may be conveyed through symbols in the legend 106. For example, a symbol for a message packet may be adorned with a bar graph symbol indicating its contribution to the total packets displayed. Any information related to the displayed symbolic representation may be represented in the legend 106, including information derived from the symbolic representation.

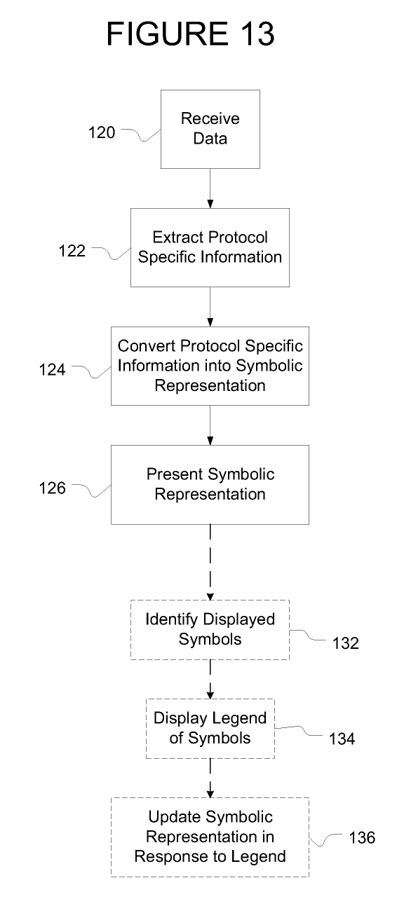

FIG. 13 is a flowchart illustrating a method of displaying a symbolic representation of data according to another embodiment of the invention. The symbols used in the symbolic representation are determined in 132. The determined symbols are displayed as a legend in 134. As described above, the symbolic representation may be updated in response to a user input associated with the legend in 136.

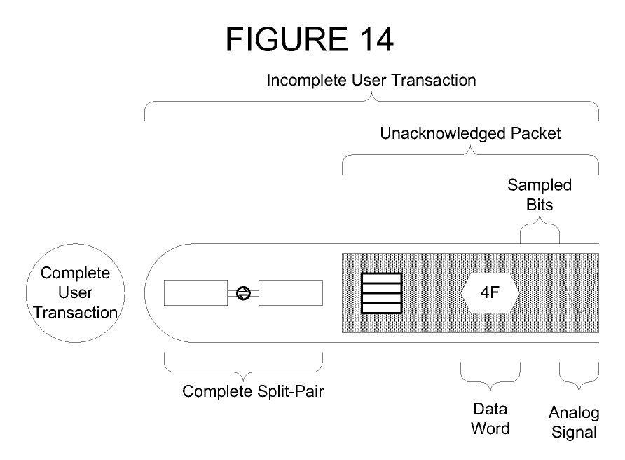

FIG. 14 is an example of a display of protocol-specific information at multiple levels of abstraction. In this example, as sufficient data or the corresponding extracted protocol-specific information is acquired, the symbolic representation is updated into a symbolic representation that may be determined from the available data.

The most recently acquired data is the analog signal. In this example, the analog signal is a representation of the signal in a physical transmission medium as detected by some acquisition apparatus. The analog signal has not yet been interpreted for data. An amount of the analog signal may have been acquired earlier sufficient to be sampled to generate the sampled bits. As a result, the sampled bits are displayed instead of the analog signal. Thus, a higher level of abstraction is displayed. However, at this point, the bits may not have enough meaning to be considered for a higher level of abstraction.

When a sufficient number of sampled bits are available, the sampled bits are assembled with other sampled bits into a data word. In this example, the data word is a hexadecimal 4F value. However, given the current state of the data, it is not clear what the data word is a part of. Thus, the data word is left at the level of abstraction displaying data words.

The levels of abstraction continue. A sufficient amount of data has been received to extract protocol-specific information indicating an unacknowledged packet. The unacknowledged packet illustrates the potential meaning of the data word, the sampled bits, and the analog signal, even though that meaning is not explicitly shown. For example, the data word may be the beginning of an acknowledgment, yet sufficient data has not been received to decide if the data is an acknowledgment.

Similarly in other levels of abstraction, transactions may be combined into a complete split-pair transaction. A sufficient amount of data indicates that a user-defined transaction is forming, yet it is still incomplete. And finally, a complete user transaction is displayed since all of the data indicating the complete user transaction has been received.

Thus, as the data or protocol-specific information becomes available, the highest level of abstraction may be used for the available data or protocol-specific information. Although the levels of abstraction are illustrated in FIG. 14 as increasing in one direction to a highest level of abstraction, the levels of abstraction may vary as desired within the symbolic representation and be limited to any levels of abstraction. For example, a highest level of abstraction may be set. As data is acquired, symbols are updated to the highest level of abstraction. However, if a particular transaction has an error, a level of abstraction used for that transaction may be set such that a point at which the error occurs becomes apparent. Thus, while portions of the symbolic representation are displayed at a higher level of abstraction, other portions are displayed at a lower level of abstraction. Furthermore, this simultaneous display of varying levels of abstraction can be in single display areas or via independent display areas such as computer window panes, separate monitors, separate devices, or the like.

Consider a series of split-pair transactions as an example. Any complete split-pair transactions may be displayed with a symbol such as the symbol of line 88 of FIG. 9. However, if there is an error in one of the split-pair transactions, for example the second half of the split-pair transaction had a not-acknowledged response, the level of abstraction may be set to display the split-pair transaction as in line 80 of FIG. 9 with the non-acknowledgment indicated by a change in the symbols. Thus, since users focus on errors in analyzing systems, completed or valid transactions are collapsed and errored transactions are highlighted, drawing the user's attention.

To aid in analysis of the protocol-specific information, a user may be able to interact with the symbolic representation. In one embodiment, referring to FIG. 8, a symbol of the symbolic representation is selected in 162. In response, the user is presented with the protocol-specific information associated with the symbol. The user may then adjust that protocol-specific information in 164. The symbolic representation is adjusted in response to the adjusted protocol-specific representation in 166.

In one example, an error, bad data, or other defect in the data may corrupt the interpretation of any subsequent data, including the protocol-specific information extracted from the data. However, since the errored data is easily accessible through the errored symbol, a user, the instrument, monitoring software, or the like may correct the error. As a result, the user may see how the corrected error affects the subsequent corrupted data or protocol-specific information. Furthermore, such correction may be indicated on the symbol associated with the corrected data. For example, an adornment may be added to the symbol indicating the correction.

In addition, other operations may be defined for interaction with the symbolic display. For example, if a user selects a symbol from the symbolic representation in 162, the symbolic representation may be adjusted to highlight symbols of the symbolic representation that are related to the selected symbol in 172. As described above, a group of protocol-specific information may be part of one related event such as a data transfer operation. By selecting one of the symbols of the group, the other symbols of the group may be highlighted to focus the user's attention. In addition, similar to the legend, described above, a selection of a symbol in the symbolic representation may highlight other similar symbols within the symbolic representation.

Furthermore, interaction with the symbolic representation may manipulate other displays of the data. In one example, debugging a system may include viewing the data in a symbolic representation and another type of a display. Such another type of a display is a listing view, a waveform view, or other views of the data.

In one embodiment, as described above, a user may select a symbol in the symbolic representation in 162. Since the symbol is associated with protocol-specific information within the data, the focus of the other views of the data may be changed in response to display the data associated with the symbol in 172. Furthermore, the reverse is possible. A user may manipulate one of the other displays of the data. In response the symbolic representation is adjusted to focus on the symbols associated with the data in the other display.

Another embodiment is a test and measurement instrument for displaying data. The test and measurement instrument includes means for receiving data, means for extracting protocol-specific information from the data, means for converting the protocol-specific information into a symbolic representation, and means for displaying the symbolic representation.

Another embodiment of a test and measurement instrument includes means for converting the protocol-specific information into symbols according to a symbol grammar, and means for assembling the symbols into the symbolic representation.

Still another embodiment of a test and measurement instrument includes means for identifying user-defined protocol-specific information within the protocol-specific information, means for converting the user-defined protocol-specific information into symbols according to a user-defined symbol grammar, and means for assembling the symbols into the symbolic representation.

Another embodiment of a test and measurement instrument includes means for adjusting the symbolic representation to illustrate the passage of time.

As described above, various combinations of acquisition systems 10, processors 12, and displays 14 may form a test and measurement instrument. The means recited above include such combinations. Any of the above recited methods may be implemented in a test and measurement instrument through means for performing the methods such as those combinations describe above.

Although throughout this description, the terms transaction, split-pair, packet, or the like have been used as examples, embodiments are not limited to using only such organizations of data. Any term representing an organization of data according to a protocol may be used and represented by a symbol or group of symbols.

Although specific symbols have been used in the drawings as examples, the selection of symbols can be made as desired to improve the effectiveness of the symbolic representation in conveying information to a user.

Another embodiment includes an article of machine readable code embodied on a machine readable medium that when executed, causes the machine to perform any of the above described operations. As used here, a machine is any device that can execute code. Microprocessors, programmable logic devices, multiprocessor systems, digital signal processors, personal computers, or the like are all examples of such a machine.

Although particular embodiments have been described, it will be appreciated that the principles of the invention are not limited to those embodiments. Variations and modifications may be made without departing from the principles of the invention as set forth in the following claims.

1. A method of displaying data, comprising:
receiving data;
extracting protocol-specific information from the data;
converting the protocol-specific information into a symbolic representation; and
presenting the symbolic representation.

2. The method of claim 1, wherein presenting the symbolic representation comprises at least one of:
visually presenting the symbolic representation;
auditorily presenting the symbolic representation; and
tactilely presenting the symbolic representation.

3. The method of claim 1, wherein converting the protocol-specific information into the symbolic representation comprises:
converting the protocol-specific information into symbols according to a symbol grammar; and
assembling the symbols into the symbolic representation.

4. The method of claim 3, further comprising:
identifying user-defined protocol-specific information within the protocol-specific information;
wherein converting the protocol-specific information into symbols further comprises converting the user-defined protocol-specific information into symbols according to a user-defined symbol grammar.

5. The method of claim 3, wherein:
the protocol-specific information indicates an association of a first part of the protocol-specific information to a second part of the protocol-specific information; and
converting the protocol-specific information into symbols further comprises converting the association into a symbol.

6. The method of claim 3, wherein:
the protocol-specific information indicates data within a field of the protocol-specific information; and
converting the protocol-specific information into symbols further comprises converting the data within the field into a symbol.

7. The method of claim 1, further comprising:
adjusting a semantic zoom level; and
adjusting the symbolic representation in response to the semantic zoom level.

8. The method of claim 7, wherein adjusting the symbolic representation in response to the semantic zoom level comprises:
replacing a first set of symbols of the symbolic representation with a second set of symbols different from the first set such that a level of information detail of the first set of symbols is different from a level of information detail in the second set of symbols.

9. The method of claim 1, further comprising:
displaying the symbolic representation of the protocol-specific information with a symbolic representation of other related protocol-specific information along a first axis; and
displaying the symbolic representation of the protocol-specific information with a symbolic representation of other unrelated protocol-specific information along a second axis distinct from the first axis.

10. The method of claim 1, further comprising:
adjusting the symbolic representation to illustrate the passage of time.

11. The method of claim 1, further comprising:
modifying existing symbols of the symbolic representation of the protocol-specific information in response to additional protocol-specific information

12. The method of claim 1, further comprising:
determining any symbols used in the display of the symbolic representation; and
displaying the symbols as a legend.

13. The method of claim 12, further comprising:
updating the symbolic representation in response to a user input associated with the legend.

14. The method of claim 1, further comprising:
displaying the symbolic representation of the protocol-specific information at a plurality of levels of abstraction.

15. The method of claim 1, further comprising:
selecting a symbol of the symbolic representation;
adjusting the protocol-specific information associated with the symbol; and
adjusting the symbolic representation in response to the adjusted protocol-specific information.

16. The method of claim 1, further comprising:
selecting a symbol from the symbolic representation; and
assembling a user-defined protocol using the selected symbol.

17. The method of claim 1, further comprising:
selecting a symbol from the symbolic representation; and
adjusting the symbolic representation to highlight symbols of the symbolic representation related to the selected symbol.

18. The method of claim 1, further comprising:
selecting a symbol from the symbolic representation; and
adjusting another display of the data in response to the selected symbol.

19. A test and measurement instrument for displaying data, comprising:
an acquisition system configured to receive an input signal;
a processor coupled to the acquisition system and configured to generate a symbolic representation of protocol-specific information within the input signal; and
a user interface coupled to the processor and configured to present the symbolic representation.

20. The test and measurement instrument of claim 19, further comprising at least one of:
a display coupled to the user interface and configured to display the symbolic representation;
a tactile interface coupled to the user interface and configured to present the symbolic representation; and
a auditory interface coupled to the user interface and configured to present the symbolic representation.

21. The test and measurement instrument of claim 19, wherein:
the user interface is configured to adjust the symbolic representation to be presented in response to a user input.

22. The test and measurement instrument of claim 19, further comprising:
a semantic zoom interface configured to adjust a level of abstraction of the symbolic representation in response to the user input.

23. The test and measurement instrument of claim 19, further comprising:
a legend interface configured to adjust the symbolic representation in response to a selection of an icon of the legend interface through the user input such that symbols of the symbolic representation that match the selected icon of the legend interface are highlighted.

24. The test and measurement instrument of claim 19, further comprising:
a level of abstraction interface coupled to the processor and configured to adjust an abstraction range of the symbolic representation.

25. The test and measurement instrument of claim 19, further comprising:
a user protocol interface coupled to the processor and configured to receive an association of a user protocol and a user-defined symbolic grammar;
wherein the processor is further configured to adjust the symbolic representation according to the user-defined symbolic grammar.

26. The test and measurement instrument of claim 19, further comprising:
a symbol manipulation interface coupled to the processor and configured to adjust protocol-specific information associated with a selected symbol in response to the user input.

27. A system for displaying data, comprising:
means for receiving data;
means for extracting protocol-specific information from the data;
means for converting the protocol-specific information into a symbolic representation; and
means for presenting the symbolic representation.

28. The system of claim 27, further comprising:
means for converting the protocol-specific information into symbols according to a symbol grammar; and
means for assembling the symbols into the symbolic representation.

29. The system of claim 27, further comprising:
means for identifying user-defined protocol-specific information within the protocol-specific information;
means for converting the user-defined protocol-specific information into symbols according to a user-defined symbol grammar; and
means for assembling the symbols into the symbolic representation.

30. The system of claim 27, further comprising:
means for adjusting the symbolic representation to illustrate the passage of time.

31. An article of machine readable code embodied on a machine readable medium that, when executed, causes a machine to:
receive data;
extract protocol-specific information from the data;
convert the protocol-specific information into a symbolic representation; and
present the symbolic representation.

32. The article of machine readable code of claim 31 that, when executed, causes a machine to:
convert the protocol-specific information into symbols according to a symbol grammar; and
assemble the symbols into the symbolic representation.

33. The article of machine readable code of claim 31 that, when executed, causes a machine to:
identify user-defined protocol-specific information within the protocol-specific information;
convert the user-defined protocol-specific information into symbols according to a user-defined symbol grammar; and
assemble the symbols into the symbolic representation.

34. The article of machine readable code of claim 31 that, when executed, causes a machine to:
adjust the symbolic representation to illustrate the passage of time.
